(19) United States
(12) Patent Application Publication
(10) Pub. No.: US 2006/0095303 A1
(43) Pub. Date: May 4, 2006

(54) Method and apparatus for a generic mechanism for adjudication of claims in a claims processing system

(76) Inventors: Robert Baldwin, Frisco, TX (US); Ricky Drennan, Wylie, TX (US)

Correspondence Address: DUKE W. YEE, YEE & ASSOCIATES, P.C., P.O. BOX 802333, DALLAS, TX, 75380, US

(21) Appl. No.: 10/982,363

(22) Filed: Nov. 4, 2004

(51) Int. Cl. G06Q 40/00; G06Q 10/00; G06F 17/21

(52) U.S. Cl. 705/4; 705/2; 715/513

(57) ABSTRACT

A method and system for a generic mechanism for adjudication of claims in a claims processing system. The generic mechanism comprises a Web services module, a Web portal, a batch loader, a claim database, and an interface engine. The Web services module, the Web portal, and the batch loader are used by medical providers to submit claims. Upon submission, claim information is converted to generic messages and sent to the interface engine. The interface engine validates the generic messages using a claim schema, prior to converting them to an internal message format, and sending them to a clearing house application. When messages are adjudicated by the clearing house application, they are returned to the interface engine, where the return messages are converted back to generic messages and validated against a return message schema. Valid messages along with any error are returned to the medical providers and submitted for payment approval.

### BACKGROUND OF THE INVENTION

1. Technical Field

The present invention relates to an improved health care system. In particular, the present invention relates to adjudication of claims in a claims processing system. Still more particularly, the present invention relates to a generic mechanism for adjudication of claims in a claims processing system.

2. Description of Related Art

Claims-processing in health care is a highly complex task. Typically, a claim for payment is submitted by a medical provider to one or more payers after a patient visit. Examples of medical providers include physicians and physician groups, hospitals, medical centers, pharmacies, and laboratories. Examples of payers include commercial health and accident insurance companies, workers' compensation organizations, third party administrators, managed care companies, pharmaceutical companies, and government agencies.

Under current claims-processing environment, most medical providers do not submit their claims directly to the payers. Instead, the medical providers submit their claims to a clearing house application, which verifies and validates the claims against a set of rules defined by the payers. The clearing house application also provides an electronic connection to the payers for adjudication and returns the results to the medical providers. Each payer defines its own set of rules for validating claims by adjudicating the claims against a defined set of business rules. The business rules include requirements for accepting the claims, such as, for example, patient's name, date of birth, and social security number, etc. The process of accepting claims, validating claims based on a set of pre-defined rules, and returning results of the claims is known as adjudication.

One example of a clearing house application is Claims Manager, a product available from Ingenix, Inc. Claims Manager accepts claim transactions from medical providers, analyzes the transactions based on a set of rules pre-defined by the payers, and returns results including information about the correctness of data in the submitted claim. If the claim is valid, Claims Manager returns the claim and the transaction results.

However, clearing house applications, such as Claims Manager, requires the medical providers to submit the claims using a proprietary internal message format, for example, the Ingenix message format, developed by Ingenix, Inc. The internal message format creates problems for developers of host systems used by the medical providers, since developers must codify the host systems to translate information submitted by the providers to the internal message format. This creates additional overhead in time and cost for the medical providers.

In addition, most claims-processing applications currently used by host systems are client-based applications, which require installations on the host systems prior to operation. This leads to an abundance of maintenance issues, as updates to these applications have to be manually installed. Therefore, there is an increasing demand for a Web based solution for claims adjudication that does not require manual maintenance and may run on different platforms.

Therefore, it would be advantageous to have an improved method, apparatus, and computer instructions for a generic mechanism for adjudication of claims in a claims processing environment, such that medical providers may submit claims for validation generically without first converting the information into an internal message format.

### SUMMARY OF THE INVENTION

A method, apparatus, and computer instructions are provided for a generic mechanism for adjudication of claims for a claims processing system. In a preferred embodiment, medical providers may submit claims via a Web service module. In an alternative embodiment, claims may be submitted via a Web portal from a third party practice management system. When the claims are received, the Web service module or the Web portal converts claim information into a generic message format. The generic messages are sent, either directly from the Web service module or via a batch loader, to an interface engine where they are validated using a claim schema.

If the messages are valid, the interface engine converts the generic messages to an internal message format and sends the internal messages along with a set of templates obtained from the payers to a clearing house application for adjudication. When return messages are received from the clearing house application, the interface engine converts the return messages back to generic messages and validates the generic messages with a return message schema. The valid generic messages are returned to the host system and sent to the payer for approval. The invalid messages are returned to the host system for correction.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating a known claims processing system for the adjudication of claims;

FIG. 5 is a diagram illustrating a generic mechanism for adjudication of claims in accordance with a preferred embodiment of the present invention;

FIG. 6 is a diagram of an exemplary valid message according to the internal message format in accordance with a preferred embodiment of the present invention;

FIG. 7A is an exemplary claim schema for validation of claim message in accordance with a preferred embodiment of the present invention;

FIG. 7B is an exemplary claim schema for validation of claim message with line segment 708 in accordance with a preferred embodiment of the present invention;

FIG. 7C is an exemplary claim schema for validation of claim message with history segment 710 in accordance with a preferred embodiment of the present invention;

FIG. 8A is an exemplary return message schema for validation of return internal message in accordance with a preferred embodiment of the present invention;

FIG. 8B is an exemplary return message schema for validation of return internal message with line segment 808 and message id segment 810 in accordance with a preferred embodiment of the present invention;

FIG. 8C is an exemplary return message schema for validation of return internal message with result line segment 806 in accordance with a preferred embodiment of the present invention;

FIG. 9A is a flowchart of an exemplary process for adjudication of claims performed by a Web service module in accordance with a preferred embodiment of the present invention;

FIG. 9B is a flowchart of an exemplary process for adjudication of claims performed by a Web portal in accordance with a preferred embodiment of the present invention;

FIG. 9C is a flowchart of an exemplary process for adjudication of claims performed by a batch loader in accordance with a preferred embodiment of the present invention; and

FIG. 10 is a flowchart of an exemplary process for adjudication of claims performed by an interface engine in accordance with a preferred embodiment of the present invention.

### DETAILED DESCRIPTION OF THE PREFERRED EMBODIMENT

The present invention provides a method, apparatus, and computer instructions for a generic mechanism for adjudication of claims in a claims processing system. The present invention provides a generic mechanism, which includes an interface engine that operates between host systems and clearing house applications, such as Claims Manager. In addition, the mechanism of the present invention includes a Web services module that interacts with a smart client for gathering claims information. Furthermore, the mechanism of the present invention includes a Web portal that handles high volume claim submission from multiple medical providers.

The Web portal of the present invention may interact with a practice management system (PMS) to batch load a high volume of claims. PMS are third party applications that medical providers use to manage their practice. PMS includes patients' bibliographical information and medical histories. By providing a Web portal to PMS, medical providers may directly upload a batch of claims using information from PMS without having to manually input individual patient information and histories. All that medical providers have to do is to ensure the information in PMS conforms to the interface engine of the present invention.

When a medical provider inputs claim information, through a Web service module at a host system, the claim information is formatted into messages in a markup language format, such as extensible markup language (XML). However, other generic message format may also be used. After claim information is formatted into XML messages, the Web service module sends the messages to the interface engine of the present invention.

If the claims are submitted via a third party PMS, the Web portal converts the claim information into XML messages and uploads the messages to a batch loader. The batch loader periodically checks to see if messages are uploaded and sends uploaded messages to the interface engine of the present invention.

The interface engine of the present invention facilitates adjudication of claims by using two extensible markup language (XML) schemas: a claim schema and a return message schema. The interface engine of the present invention first validates the XML messages using the claim schema. The claim schema defines a set of elements that represent different segments of a message according to the internal message format.

If the messages are validated, the interface engine of the present invention then converts the XML messages into the internal message format and submits the internal messages to the clearing house application, such as Claims Manager. In turn, the clearing house application uses templates defined by each payer to determine if there are any errors associated with the messages received. Templates include a set of rules defined by each payer for adjudication of claims. In a preferred embodiment, the templates are obtained by the interface engine from the payers. If the messages include any errors, the clearing house application returns those messages with the error to the interface engine of the present invention. Otherwise, the clearing house application simply returns the messages. The returned messages are adjudicated messages.

When the interface engine of the present invention receives the adjudicated messages, the interface engine converts these messages from the internal message format back to a markup language format, such as extensible markup language (XML). After the adjudicated messages are converted, the interface engine of the present invention validates the XML adjudicated messages by using a return message schema. Once the XML adjudicated messages are validated, the XML messages are sent back to the Web service module.

If the claim is adjudicated successfully, meaning that no error is found, the Web service module may format the claim into a Health Level Seven (HL7) extensible markup language (XML) format and send the claim to the payer for approval. HL7 is an American National Standards Institute (ANSI) standard of electronic data transfer for a particular health domain, such as the insurance domain. Level Seven refers to the application level, which addresses the definition of data to be exchanged, the timing of the interchange, and the communication of certain errors to the application.

When the payer approves the claim, the payer sends an approval message back to either the Web portal or the Web service module. Thus, claim processing is complete. On the other hand, if the claim is not adjudicated successfully, meaning that errors need to be corrected, the Web service module notifies the medical provider to correct the errors and resubmit the claim for a second adjudication. The following figures provide an overview of a background and detail descriptions of preferred embodiments of the present invention.

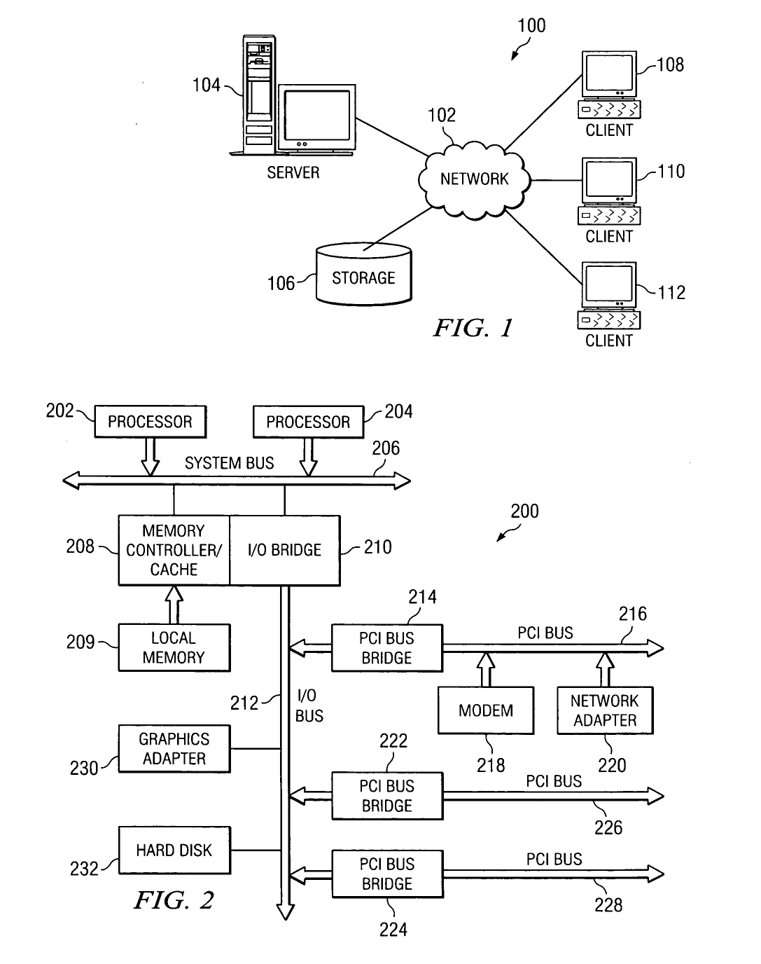

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

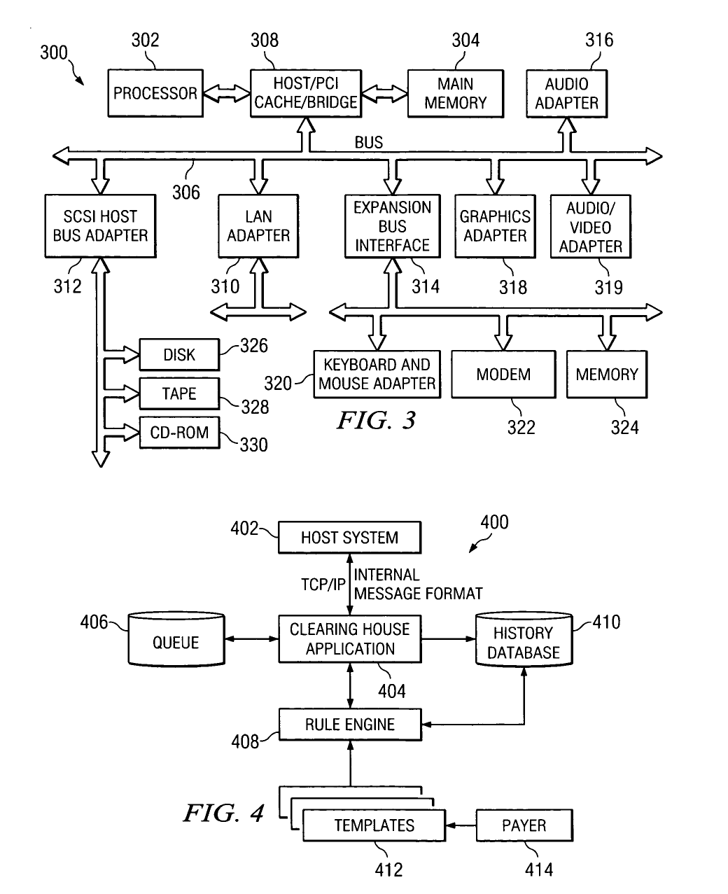

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning now to FIG. 4, a diagram illustrating a known claims processing system for the adjudication of claims is depicted. As depicted in FIG. 4, claims processing system 400 includes host system 402, clearing house application 404, queue 406, rule engine 408, and history database 410. Host system 402 may be implemented as a data processing system, such as data processing system 300 in FIG. 3. Clearing house application 404, queue 406, rule engine 408, and history database 410 may be implemented in a server, such as data processing system 200 in FIG. 2.

When a medical provider submits a claim via host system 402, host system 402 converts the claim information into an internal message format understood by clearing house application 404. Host system 402 then connects to clearing house application 404 using a communication protocol, such as TCP/IP, and transmits the claim to clearing house application 404 for adjudication.

Upon receiving the claim, clearing house application 404 either places the claim in queue 406 for later processing or adjudicates the claim using a set of rules defined by payer 414 in a number of templates 412. Templates 412 are stored in rule engine 408. Once the claim is adjudicated, the claim is stored as a record in history database 410 prior to being returned to host system 402.

As shown in FIG. 4, host system 402 has to have knowledge of the internal message format in order to convert the claim information into internal messages. This creates additional overhead in time and cost to medical providers, since each host system has to be customized to accommodate the internal message format.

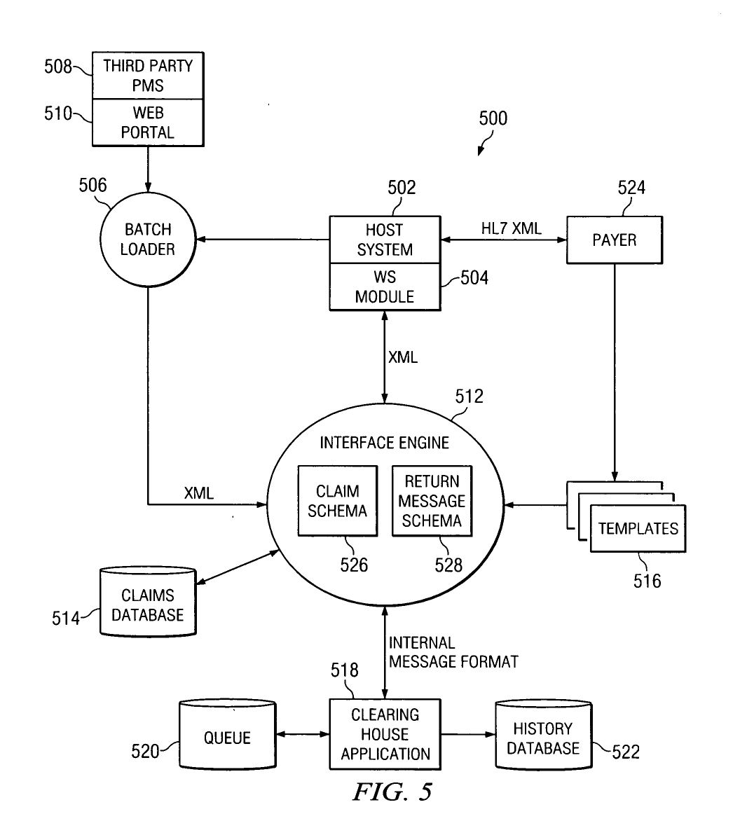

Turning now to FIG. 5, a diagram illustrating a generic mechanism for adjudication of claims is depicted in accordance with a preferred embodiment of the present invention. As shown in FIG. 5, in this example implementation, claims processing system 500 includes a generic mechanism that comprises Web services module 504, batch loader 506, Web portal 510, and interface engine 512. Web services module 504 may be implemented in a client, such as data processing system 300 in FIG. 3. Batch loader 506, Web portal 510, and interface engine 512 may be implemented in a server, such as data processing system 200 in FIG. 2.

When medical providers submit a claim via host system 502, the present invention provides Web service module 504 that may be implemented in association with host system 502, such that medical providers may enter claim information via a Web browser. Web service module 504 may be implemented using any existing Web services platform, including Microsoft .NET, a product available from Microsoft Corporation.

Upon receiving claim information, instead of directly submitting the claim to clearing house application 518, Web services module 504 parses the claim information and converts the information into generic messages using a markup language format, such as extensible markup language (XML). Web services module 504 then sends the XML messages to interface engine 512, which validates the XML messages with claim schema 526 before converting the XML messages into an internal message format. In this way, host system 502 does not have to have knowledge of internal message format in order to submit claims for adjudication.

Claim schema 526 identifies segments of an internal message according to the internal message format that are required for clearing house application 518 to adjudicate the claim. If the XML messages are validated, meaning that the XML messages are valid messages according to the internal message format, interface engine 512 converts the XML messages to the internal message format and sends the messages to clearing house application 518.

On the other hand, instead of submitting each claim individually, medical providers may submit high volumes of claims via host system 502 using a third party practice management system (PMS) 508. PMS 508 is a system used by medical providers for managing their practices. PMS 508 includes patient bibliographical information and medical histories.

When medical providers submit their claims using PMS 508, the claims are submitted via Web portal 510, which is a Web-based interface that uploads claims from PMS 508 to batch loader 506. Before claims are uploaded from PMS 508 to batch loader 506, Web portal 510 converts the claim information into generic messages using a markup language format, such as extensible markup language (XML).

Batch loader 506 checks periodically for messages that are submitted by PMS 508 via Web portal 510. When batch loader 506 detects a set of submitted messages, batch loader 506 sends the XML messages to interface engine 512. Similarly, interface engine 512 validates the XML messages with claim schema 526 before converting the XML messages to the internal message format and sending the messages to clearing house application 518.

Before internal messages from Web services module 504 or batch loader 506 are sent to clearing house application 518, interface engine 512 obtains a set of rules defined by payer 524 using a set of templates 516. Templates 516 are used by clearing house application 518 to adjudicate claims and detect if there are any errors in the submitted messages. Interface engine 512 then sends the internal messages with the templates 516 obtained from payer 524 to clearing house application 518.

When clearing house application 518 receives the internal messages and templates 516, clearing house application 518 either places the internal messages in queue 520 or adjudicates the claims within the internal messages. Unlike clearing house application 404 in FIG. 4, clearing house application 518 does not store templates from payer 524. Instead, clearing house application 518 uses templates 516 received from interface engine 512 to adjudicate the claims.

Once the claims within the internal messages are adjudicated, clearing house application 518 places claim results in history database 522 prior to returning them to interface engine 512 in the internal message format. Interface engine 512 then converts the return messages back to a markup language format, such as extensible markup language, and validates the XML return messages with return message schema 528. Return message schema 528 identifies components of a return message, including error components.

Once the return messages are validated, interface engine 512 places the claim results within the return messages in claims database 514 for future reference. If the claims are adjudicated successfully, interface engine 512 returns the claim results in XML format to host system 502 via a Web service module 504. If claim adjudication is not successful, meaning that there are errors within the claims, interface engine 512 returns the claim results with errors to host system 502 via a Web service module 504. Medical providers may then correct the errors and repeat the adjudication process.

Thus, the generic mechanism of the present invention replaces most of the clearing house function that was provided by clearing house application 404 and rule engine 408 in FIG. 4. By using the generic mechanism of the present invention, medical providers may submit claims for adjudication using a Web-based interface. In addition, medical providers may also upload claims from a third party practice management system in a high volume fashion via a Web portal to a batch loader.

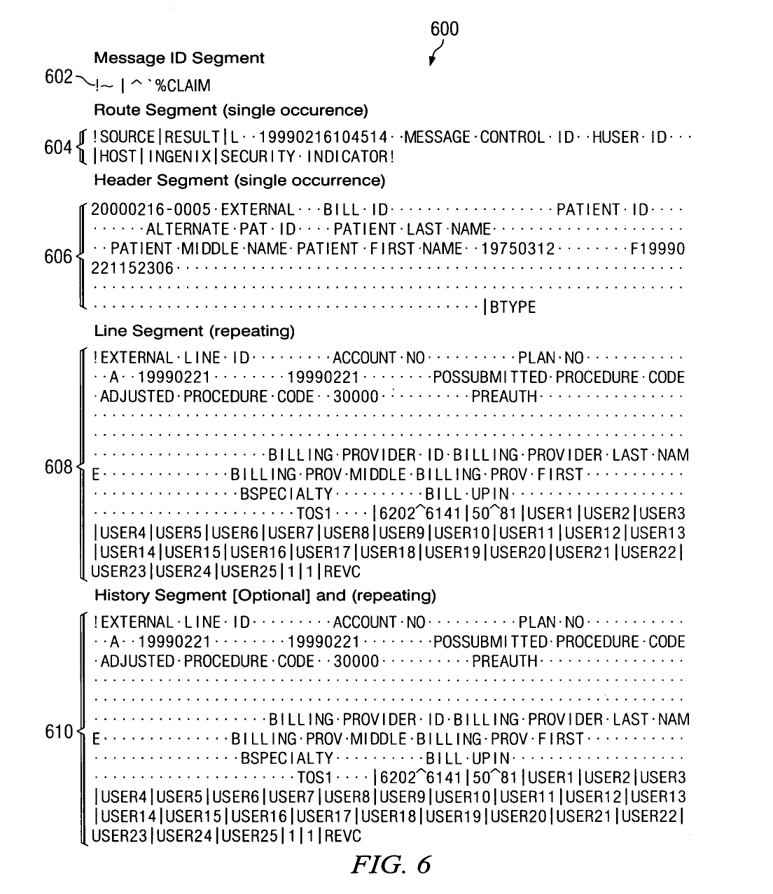

Turning now to FIG. 6, a diagram of an exemplary valid message according to the internal message format is depicted in accordance with a preferred embodiment of the present invention. As shown in FIG. 6, claim message 600 includes message identifier (ID) segment 602, route segment 604, header segment 606, line segment 608, and history segment 610. Line segment 608 and history segment 610 may be repeated throughout the message. History segment 610 is an optional segment.

Claim message 600 is formatted using ANSI characters and are delimited by various symbols. For example, the ‘!’ symbol is used to delimit segments, and the ‘|’ symbol is used to delimit fields. As shown in FIG. 6, message id segment 602 identifies the unique claim message. Route segment 604 identifies where the message should route to, including the sending application and the receiving application. Header segment 606 identifies who submitted the claim as well as the patient's bibliographical information, such as the patient's name, date of birth, etc.

Line segment 608 is a repeated segment. Line segment 608 identifies detail claim information, including the date of service provided by the medical provider, the amount of the service, what treatment was provided, and plan and account information for the patient's health care plan. History segment 610 has a format that is identical to the format of line segment 608. History segment 610 is optional and may be repeated to identify a history of claims that are submitted by the medical provider.

In order for medical providers to send claim messages to the clearing house application, the developers of the host system must first convert claim information received into segmentations and delimiters used in claim message 600. This creates an overhead in development time and labor cost for medical providers, who must adhere to the internal message format.

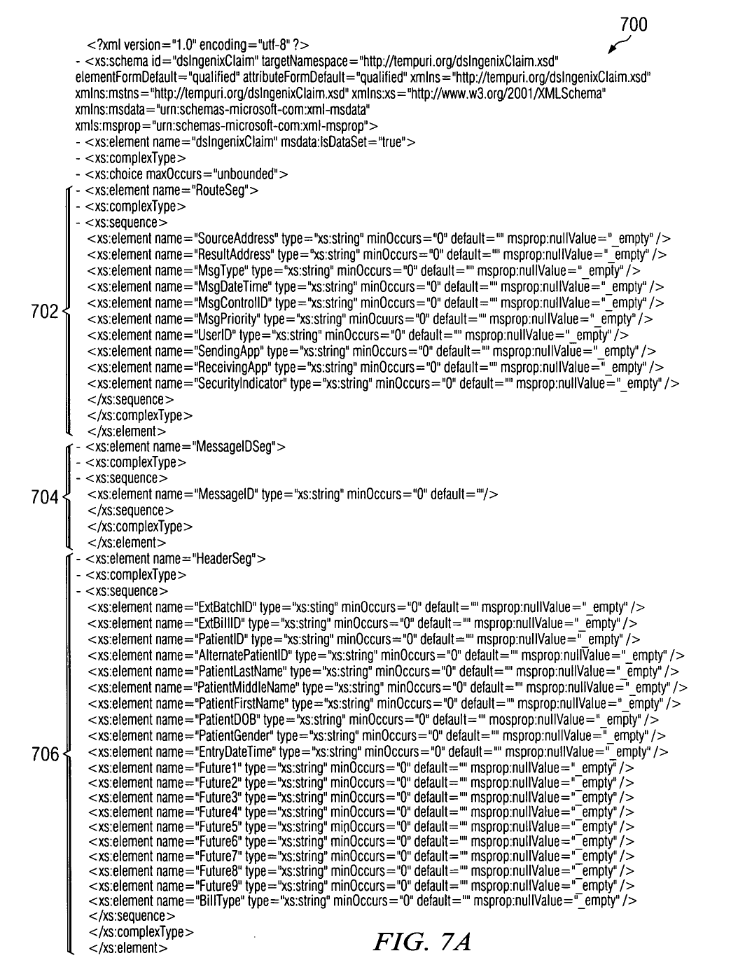

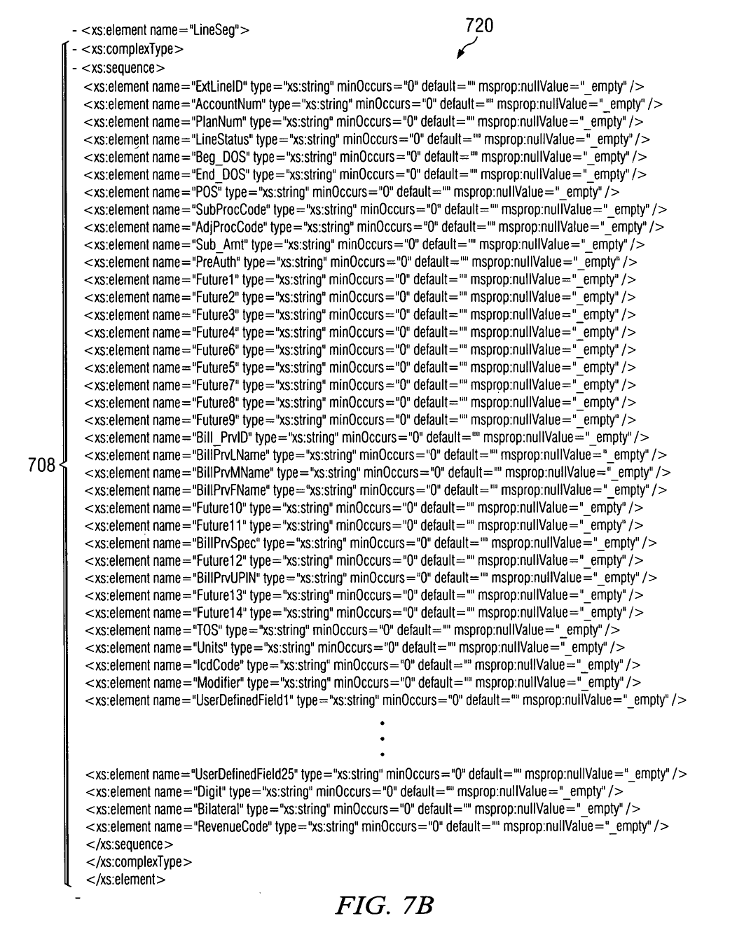

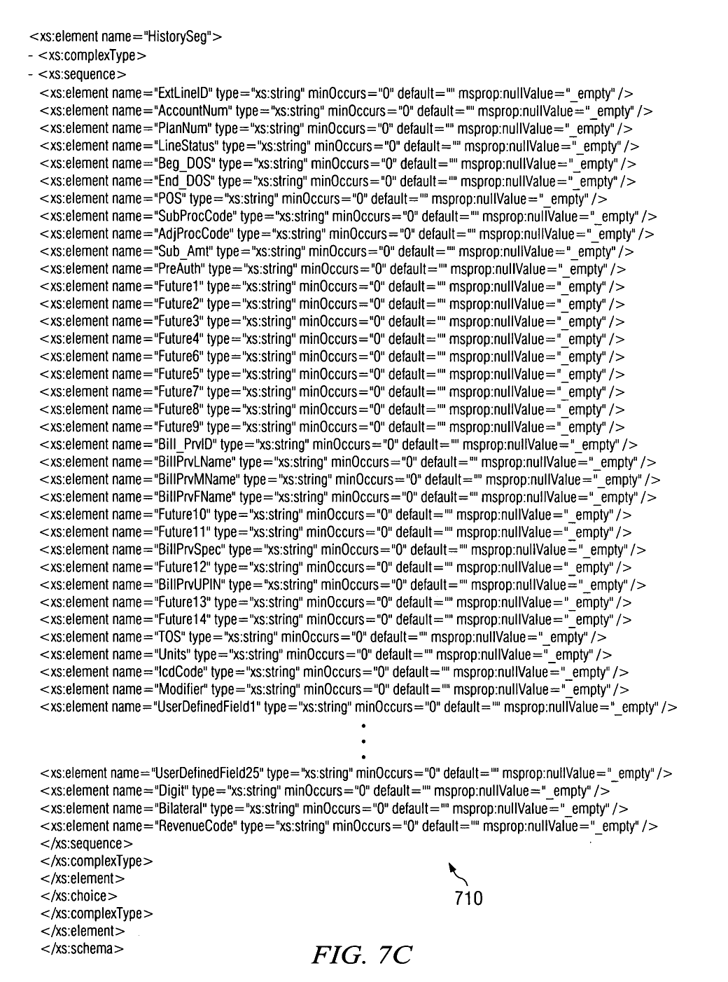

Turning now to FIG. 7A, an exemplary claim schema for validation of claim message is depicted in accordance with a preferred embodiment of the present invention. As shown in FIG. 7A, in this example implementation, claim schema 700 is used by the interface engine of the present invention to validate XML messages submitted by medical providers against the internal message format. Similar to claim message 600 in FIG. 6, claim schema 700 includes a message ID segment 704 for identifying a unique claim message. Claim schema 700 also includes route segment 702 and header segment 706. Claim schema 700 continues with line segment 708 in FIG. 7B, and history segment 710 in FIG. 7C.

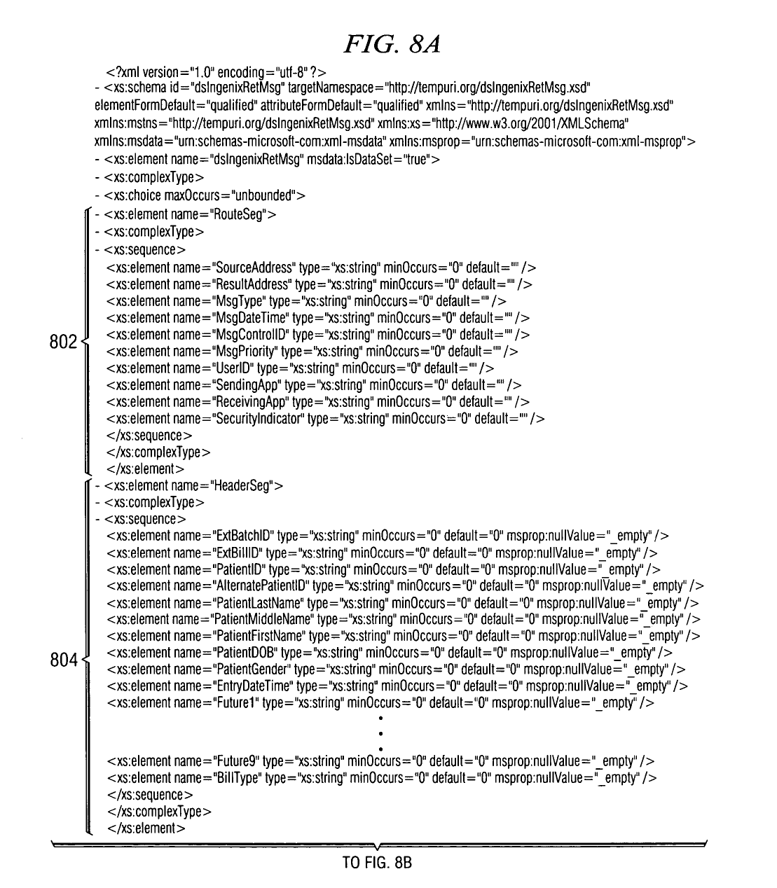

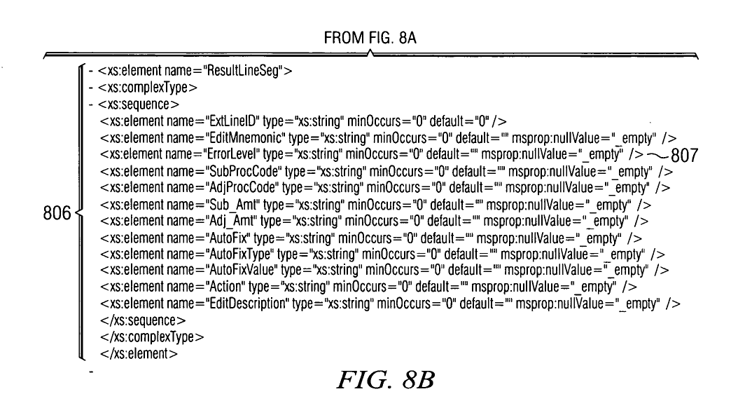

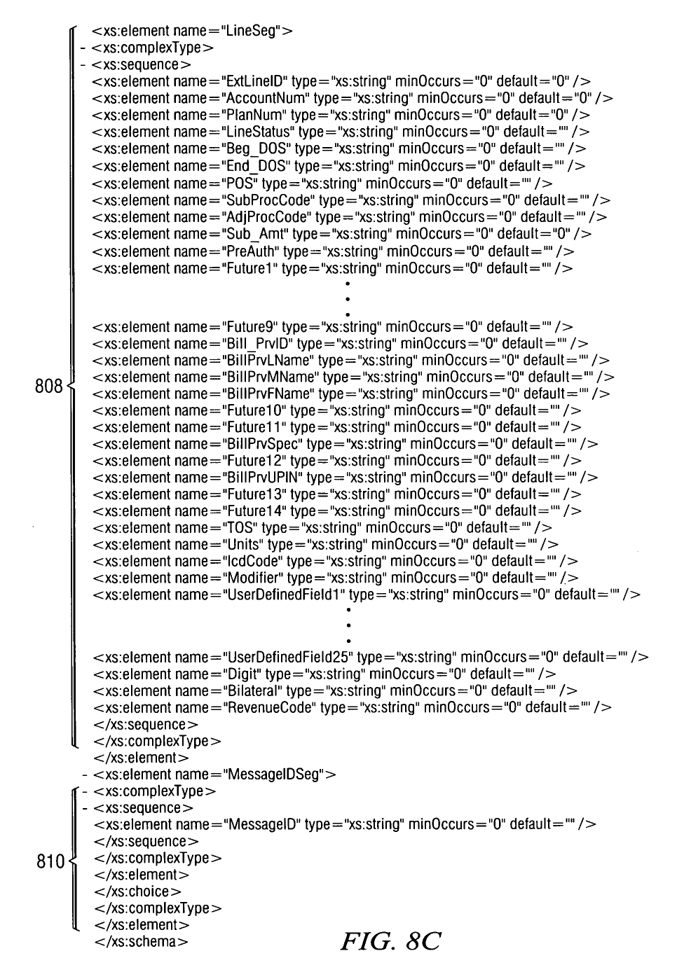

Turning now to FIG. 8A, an exemplary return message schema for validation of return internal message is depicted in accordance with a preferred embodiment of the present invention. As shown in FIG. 8A, in this example implementation, similar to claim schema 700 in FIGS. 7A and 7B, return message schema 800 includes segments, such as, for example, route segment 802, header segment 804.

In addition, return message schema 800 includes line segment 808 and message id segment 810 in FIG. 8B, and result line segment 806 in FIG. 8C, which defines claim results returned by clearing house application. An error level 807 is provided to identify an error in the claim result.

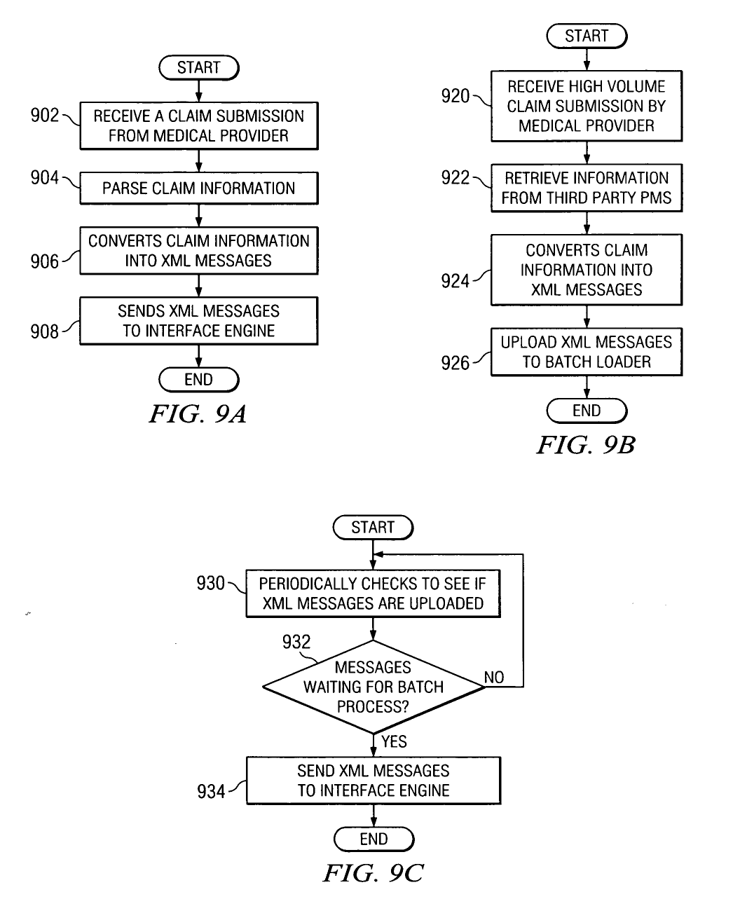

Turning now to FIG. 9A, a flowchart of an exemplary process for adjudication of claims performed by a Web service module is depicted in accordance with a preferred embodiment of the present invention. As shown in FIG. 9A, the process begins when the Web service module receives a claim submission from a medical provider (step 902). The medical provider may enter claim information via a Web-based interface using a Web browser. The Web service module may be implemented on any Web services platform, including Microsoft .NET platform.

Once the claim submission is received, the Web service module parses claim information from the Web-based interface (step 904) and converts the claim information into a generic message format, such as XML format (step 906). Once the claim information is converted into XML messages, the Web service module then sends XML messages to the interface engine (step 908) for adjudication. Thus, the process terminates thereafter.

Turning now to FIG. 9B, a flowchart of an exemplary process for adjudication of claims performed by a Web portal is depicted in accordance with a preferred embodiment of the present invention. As shown in FIG. 9B, the process begins when a high volume submission request is received from the medical provider (step 920). The Web portal retrieves information from a third party practice management system (PMS) (step 922), such as claim and patient information. The Web portal then converts the information retrieved into a generic message format, such as XML format (step 924) and uploads the XML messages to a batch loader for submission (step 926). Thus, the process terminates thereafter.

Turning now to FIG. 9C, a flowchart of an exemplary process for adjudication of claims performed by a batch loader is depicted in accordance with a preferred embodiment of the present invention. As shown in FIG. 9C, the process begins when the batch loader periodically checks to see if XML messages are uploaded via a Web portal (step 930). The batch loader then makes a determination as to whether messages are awaiting batch processing (step 932). If messages are waiting for batch processing, the batch loader sends XML messages to the interface engine for adjudication (step 934) and the process terminates thereafter.

However, if no messages are waiting for batch processing, the batch loader returns to step 930 to periodically check to see if new XML messages are uploaded.

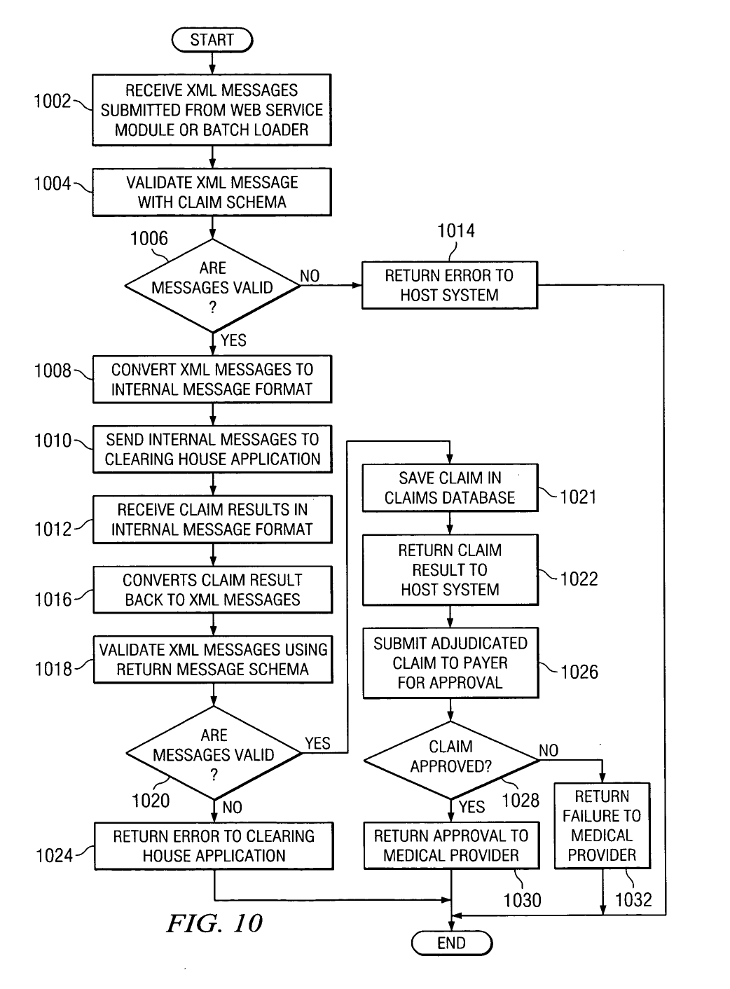

Turning now to FIG. 10, a flowchart of an exemplary process for adjudication of claims performed by an interface engine is depicted in accordance with a preferred embodiment of the present invention. As shown in FIG. 10, the process begins when the interface engine receives XML messages from either the Web service module or the batch loader (step 1002).

The interface engine validates the XML messages received with a claim schema (step 1004) and determines if the messages are valid according to the internal message format as defined in the claim schema (step 1006). If the messages are not valid, the interface engine returns an error to the host system (step 1014) and the process terminates thereafter.

If the messages are valid, the interface engine converts the XML messages to internal message format (step 1008) and sends the internal messages to clearing house application for adjudication (step 1010).

When adjudication is complete, the interface engine receives the claim results from clearing house application (step 1012) and converts the claim results back to XML messages (step 1016). Once the claim results are converted back to XML messages, the interface engine validates the messages by using the return message schema (step 1018).

A determination is then made by the interface engine as to whether the messages are valid (step 1020). If the messages are not valid, an error is returned to the clearing house application to resend correct claim results (step 1024) and the process terminates thereafter. If the messages are valid, the interface engine saves the claim results in a claim database (step 1021) for future reference and returns the claim results back to the host system (step 1022).

The host system then submits the adjudicated claims to payer for approval (step 1026). A determination is made by the payer as to whether the claim is approved (step 1028). If the payer approves the claim, an approval is returned by the payer to the medical provider via the host system (step 1030). Otherwise, a failure to approve is returned by the payer to the medical provider via the host system (step 1032) and the process terminates thereafter.

In summary, the generic mechanism of the present invention has advantages over the prior art, in that development cost is greatly reduced by eliminating the requirement of the internal message format knowledge from the host system. With the generic mechanism of the present invention, medical providers may submit claims for adjudication without having knowledge of the internal message format or the clearing house application. In addition, medical providers may submit claims using a Web-based interface provided by the generic mechanism via a Web service module. Furthermore, a high volume of claims may be submitted for adjudication from a third party practice management system via Web portal without involvement of the host system. Moreover, the templates defined by the payer may directly be obtained by the interface engine without using the clearing house application. Also, claim results are now accessible via the claim database provided by the present invention for medical providers' use for backup, storage, and maintenance.

It is important to note that while the present invention has been described in the context of a fully functioning data processing system. Those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for adjudication of claims in a claims processing system, the method comprising:
receiving at least one claim submission from a host system;
converting the at least one claim submission to at least one generic message;
validating the at least one generic message;
converting the at least one valid generic message to at least one formatted message, wherein the at least one formatted message is formatted using a format designated by a clearing house application; and
sending at least one formatted message to the clearing house application for adjudication.

2. The method of claim 1, further comprising:
responsive to receiving at least one return message from the clearing house application, converting the at least one return message to at least one generic return message;
validating the at least one generic return message; and
sending the at least one valid generic return message to the host system.

3. The method of claim 2, further comprising:
responsive to receiving at least one valid generic return message, determining if the at least one valid generic return message includes at least one error; and
if the at least one valid generic return message includes at least one error, sending the at least one generic return message with the at least one error to a medical provider for correction.

4. The method of claim 3, further comprising:
if the at least one valid generic return message does not include at least one error, saving the at least one valid generic return message in a claim database;
returning the at least one valid generic return message to the medical provider; and
sending the at least one claim submission from the host system to at least one payer for approval.

5. The method of claim 1, wherein the at least one claim submission includes information of a medical claim, and wherein the at least one claim submission is received at one of a Web portal and a Web service module.

6. The method of claim 2, wherein the at least one generic message and the at least one generic return message are formatted using a markup language, and wherein the markup language is extensible markup language.

7. The method of claim 1, wherein the at least one generic message is validated using a claim schema and wherein the claim schema defines components of the at least one formatted message.

8. The method of claim 1, wherein the clearing house application adjudicates the at least one formatted message using a set of rules, and wherein the set of rules is defined by at least one payer using a set of templates.

9. The method of claim 8, wherein the set of templates is obtained from the at least one payer by an interface engine.

10. The method of claim 5, wherein the first converting step is performed by one of the Web portal and a Web service module, and wherein the second performing step is performed by an interface engine.

11. The method of claim 2, wherein the at least one generic return message is validated using a return message schema, and wherein the return message schema defines components of a valid return message.

12. The method of claim 4, wherein the at least one claim submission is sent using a markup language message, wherein the markup language is high level seven extensible markup language.

13. The method of claim 1, wherein the at least one claim submission is uploaded from a third party system via a batch loader, and wherein the batch loader periodically checks if a claim is submitted.

14. The method of claim 1, wherein the at least one claim submission is submitted by a medical provider using a Web-based interface, and wherein the medical provider includes one of a physician, hospital, medical center, pharmacies, and laboratories.

15. The method of claim 4, wherein the at least one payer includes commercial health insurance companies, managed care companies, pharmaceutical companies, third party administrators, workers' compensation organizations, and government agencies.

16. A method for adjudication of claims in a claims processing system, the method comprising:
receiving a request for adjudication of claims from a host system;
converting the request to a generic request, wherein the generic request is formatted in a first markup language;
validating the generic request using a first schema;
converting the validated generic request to a proprietary request; and
sending the proprietary request and a set of rules to a rule engine for adjudication.

17. The method of claim 16, further comprising:
responsive to receiving a return proprietary response from the rule engine, converting the return proprietary response to a generic response using the first markup language;
validating the generic response using a second schema; and
determining if the validated generic response includes an error.

18. The method of claim 17, further comprising:
if the validated generic response includes an error, returning the validated generic response to the host system for correction;
if the validated generic response does not include an error, saving the validated generic response to a claim database;
returning the validated generic response to the host system; and
sending the validated generic response from the host system to a payer for payment approval, wherein the validated generic response is formatted using a second markup language.

19. A data processing system for adjudication of claims in a claims processing system, the data processing system comprising:
receiving means for receiving at least one claim submission from a host system;
first converting means for converting the at least one claim submission to at least one generic message;
first validating means for validating the at least one generic message;
second converting means for converting the at least one valid generic message to at least one formatted message, wherein the at least one formatted message is formatted using a format designated by a clearing house application; and
first sending means for sending at least one formatted message to the clearing house application for adjudication.

20. The data processing system of claim 19, further comprising:
responsive to receiving at least one return message from the clearing house application, third converting means for converting the at least one return message to at least one generic return message;
second validating means for validating the at least one generic return message; and
second sending means for sending the at least one valid generic return message to the host system.

21. The data processing system of claim 20, further comprising:
responsive to receiving at least one valid generic return message, determining means for determining if the at least one valid generic return message includes at least one error; and
if the at least one valid generic return message includes at least one error, third sending means for sending the at least one generic return message with the at least one error to a medical provider for correction.

22. The data processing system of claim 21, further comprising:
if the at least one valid generic return message does not include at least one error, saving means for saving the at least one valid generic return message in a claim database;
returning means for returning the at least one valid generic return message to the medical provider; and
fourth sending means for sending the at least one claim submission from the host system to at least one payer for approval.

23. A computer program product in a computer readable medium for adjudication of claims in a claims processing system, the computer program product comprising:
first instructions for receiving at least one claim submission from a host system;
second instructions for converting the at least one claim submission to at least one generic message;
third instructions for validating the at least one generic message;
fourth instructions for converting the at least one valid generic message to at least one formatted message, wherein the at least one formatted message is formatted using a format designated by a clearing house application; and
fifth instructions for sending at least one formatted message to the clearing house application for adjudication.

24. The computer program product of claim 23, further comprising:
responsive to receiving at least one return message from the clearing house application, sixth instructions for converting the at least one return message to at least one generic return message;
seventh instructions for validating the at least one generic return message; and
eighth instructions for sending the at least one valid generic return message to the host system.

25. The computer program product of claim 24, further comprising:
responsive to receiving at least one valid generic return message, ninth instructions for determining if the at least one valid generic return message includes at least one error; and
if the at least one valid generic return message includes at least one error, tenth instructions for sending the at least one generic return message with the at least one error to a medical provider for correction.

26. The computer program product of claim 25, further comprising:
if the at least one valid generic return message does not include at least one error, eleventh instructions for saving the at least one valid generic return message in a claim database;
twelfth instructions for returning the at least one valid generic return message to the medical provider; and
thirteenth instructions for sending the at least one claim submission from the host system to at least one payer for approval.
